(19) United States
(12) Patent Application Publication
(10) Pub. No.: US 2014/0372680 A1
(43) Pub. Date: Dec. 18, 2014

(54) EMBEDDED STORAGE AND EMBEDDED STORAGE SYSTEM

(71) Applicant: MEMORIGHT (WUHAN) CO., LTD., WUHAN, HUBEI (CN)

(72) Inventors: Magnus Tsai, Wuhan (CN); Steven Lee, Wuhan (CN)

(73) Assignee: Memoright (WUHAN) Co., Ltd, WUHAN, HUBEI (CN)

(21) Appl. No.: 14/356,157

(22) PCT Filed: Sep. 27, 2012
(86) PCT No.: PCT/CN2012/082145

§ 371 Date: Aug. 13, 2014

(30) Foreign Application Priority Data
Nov. 4, 2011 (CN) 201110345252.4

(51) Int. Cl. G06F 12/02

(52) U.S. Cl. CPC G06F 12/0246
USPC 711/103

(57) ABSTRACT

Provided are an embedded storage and an embedded storage system. The embedded storage includes a flash memory control unit, a host interface unit, and at least one off-chip flash memory interface unit. The embedded storage system includes the embedded memory and at least one expanded flash memory. The expanded flash memory performs data interaction with the flash memory control unit through the off-chip flash memory interface unit. The embedded storage and the embedded storage system can solve that because an embedded memory does not have an off-chip flash memory interface for connection to an off-chip flash memory, resulting in poor expandability for storage capacity of the embedded memory. A storage cost may further be lowered through a combination of various types of NAND flash memories.

### BACKGROUND

1. Technical Field

The present invention relates to technologies of embedded storage, and more particularly to an embedded memory and an embedded storage system having storage capacity expandability.

2. Related Art

An embedded memory is an expansion of an external memory card and has found very wide application in both the production field of mobile phones and the application field of tablet computers (Tablet PC). Referring to FIG. 1, the structure of an embedded memory 1 includes: a multimedia card (MMC) interface connected to a host, a flash memory control unit used for managing a flash memory, one NAND flash memory, and one on-chip flash memory interface used for implementing data interaction between the flash memory control unit and the NAND flash memory. One clear advantage of an embedded memory is that a NAND flash memory and a flash memory controller are packaged in one small ball grid array (BGA) package, and one external standard MMC interface is provided for a host. Such a measure not only solves a compatibility problem that occurs between a NAND flash memory and different flash memory controllers, but also further shortens a manufacturing period of a new product and reduces a research and development cost.

There are mainly three types of NAND flash memory chips in an embedded memory, that is, a single-level cell (SLC) NAND flash memory, a multi-level cell (MLC) NAND flash memory, and a triple-level cell (TLC) NAND flash memory. An SLC NAND flash memory has advantages of a fast read/write speed and a long service life, but it has a relatively high production cost and relatively small capacity. A TLC NAND flash memory has a relatively low production cost and large capacity, but it has a low read/write speed and a short service life. Indexes such as a read/write speed, a service life, capacity, and a production cost of an MLC NAND flash memory are all between those of the other two types of NAND flash memories.

The package of an existing embedded memory has only one external MMC interface for connection to a host, and absolute storage capacity and the type of a storage medium of the embedded memory depend on a NAND flash memory equipped in the package. To increase or decrease the storage capacity, the entire embedded memory needs to be redesigned, which has a complicated process and an excessively high production cost. Therefore, the entire embedded memory has poor storage expandability and cost control becomes more difficult.

### SUMMARY

A major technical problem that the present invention is to solve is to provide an embedded storage and an embedded storage system, so as to avoid a problem that storage capacity of an embedded storage is fixed resulting in poor storage capacity expandability. Furthermore, an overall storage cost of a product can be lowered.

To solve the foregoing technical problem, the technical solutions adopted in the present invention are as follows:

An embedded storage includes a flash memory control unit and a host interface unit, and further includes at least one off-chip flash memory interface unit. The flash memory control unit is connected to the host interface unit and the off-chip flash memory interface unit, and is used for implementing control on the host interface unit and the off-chip flash memory interface unit. The host interface unit provides an interface for a host externally, is connected to the flash memory control unit internally, and is used for implementing data interaction between the host and the flash memory control unit. The off-chip flash memory interface unit provides externally an interface for performing data transmission with an expanded flash memory, is connected to the flash memory control unit internally, and is used for implementing data interaction between the expanded flash memory and the flash memory control unit.

Furthermore, the host interface unit is specifically an MMC interface unit for providing an MMC interface for the host.

Furthermore, the embedded storage further includes: an on-chip flash memory and an on-chip flash memory interface unit. The on-chip flash memory is connected to the on-chip flash memory interface unit. The on-chip flash memory interface unit is further connected to the flash memory control unit, and is used for implementing data interaction between the on-chip flash memory and the flash memory control unit.

Furthermore, the on-chip flash memory is an on-chip NAND flash memory.

Furthermore, the on-chip NAND flash memory is an SLC NAND flash memory, an MLC NAND flash memory or a TLC NAND flash memory.

Furthermore, the embedded storage is a BGA package chip.

Furthermore, the interface for performing data transmission with an expanded flash memory provided by the off-chip flash memory interface unit is an NC pin of the BGA package chip.

Furthermore, the BGA package chip is a chip of an AA, AB, AC or BA specification.

An embedded storage system includes the embedded memory of any in the foregoing and an expanded flash memory, where the expanded flash memory is connected to an off-chip flash memory interface unit of the embedded memory.

Furthermore, the expanded flash memory is an expanded NAND flash memory.

Furthermore, the expanded NAND flash memory is an SLC NAND flash memory, an MLC NAND flash memory or a TLC NAND flash memory.

Furthermore, the on-chip NAND flash memory is an SLC NAND flash memory, and the expanded NAND flash memory is a TLC NAND flash memory.

Furthermore, storage capacity of the expanded flash memory is greater than or equal to storage capacity of the on-chip flash memory.

Furthermore, storage capacity of the expanded NAND flash memory is greater than or equal to storage capacity of the on-chip NAND flash memory.

The present invention has the following beneficial effects:

In the present invention, one or more off-chip flash memory interface units are disposed in an embedded memory and are connected to a flash memory control unit. Therefore, the embedded memory can further expand storage capacity of an entire embedded storage system in the case that storage capacity of the embedded memory is fixed, and storage expandability of the entire embedded storage system is improved. Furthermore, a storage type of a NAND flash memory may be selected. By selecting and combining different types of NAND flash memories, controllability for a storage cost of a product is improved, and an overall storage cost is lowered.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic structural view of an existing embedded storage 1;

FIG. 2 is a schematic structural view of an embedded storage 2 according to the present invention;

FIG. 3 is a schematic structural view of an embedded storage according to Embodiment 1 of the present invention;

FIG. 4 is a schematic structural view of an embedded storage system according to Embodiment 2 of the present invention; and

FIG. 5 is a schematic structural view of an embedded storage system according to Embodiment 3 of the present invention.

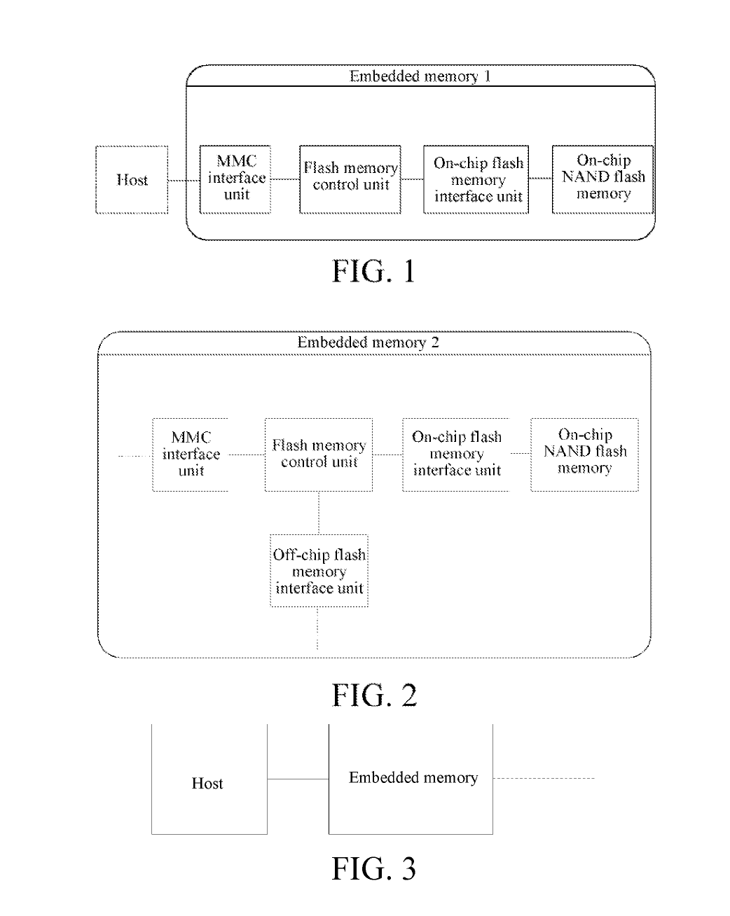

### DETAILED DESCRIPTION

To make the objectives, technical solutions, and advantages of the present invention more comprehensible, the present invention is further illustrated below in detail with reference to specific implementation manners and accompanying drawings.

Please refer to FIG. 2. FIG. 2 is a schematic structural view of an embedded storage 2 according to the present invention. A general concept of the present invention is as follows: The embedded memory of the present invention includes an on-chip NAND flash memory, a flash memory control unit, a host interface unit, an on-chip flash memory interface unit, and an off-chip flash memory interface unit. Preferably, the on-chip flash memory may be an on-chip NAND flash memory. The host interface unit may be an MMC interface unit. The on-chip flash memory, the flash memory control unit, and the on-chip flash memory interface unit may be packaged in one BGA package. A plurality of NC pins that is not used yet is provided at a position where the flash memory control unit is connected on a BGA package chip, so that these NC pins are arranged as one or more off-chip flash memory interfaces. The BGA package chip may be a chip of an AA, AB, AC or BA specification. Also, an embedded storage system is further provided. The system includes the foregoing embedded storage and one or more expanded flash memories. Preferably, the expanded flash memory may be an expanded NAND flash memory. The expanded flash memory performs data interaction with the flash memory control unit through the off-chip flash memory interface. Therefore, storage expandability of the entire embedded storage system is enhanced. Also, by selecting and combining different types of flash memories, controllability for storage cost of a product is improved, and an overall storage cost is lowered.

### Embodiment 1

Please refer to FIG. 3. FIG. 3 is a schematic structural view of an embedded storage according to Embodiment 1 of the present invention. No storage device is connected to at an external end of an off-chip flash memory interface of the embedded memory. It is proven by tests that in the premise of adding an off-chip flash memory interface unit, no storage device is connected, and a work state and work efficiency of the entire embedded memory are not affected. In addition, a flash memory and an on-chip flash memory interface unit may further be not disposed on a chip, and in this case, an expanded flash memory needs to be connected off chip, and all data is saved in the off-chip expanded flash memory.

### Embodiment 2

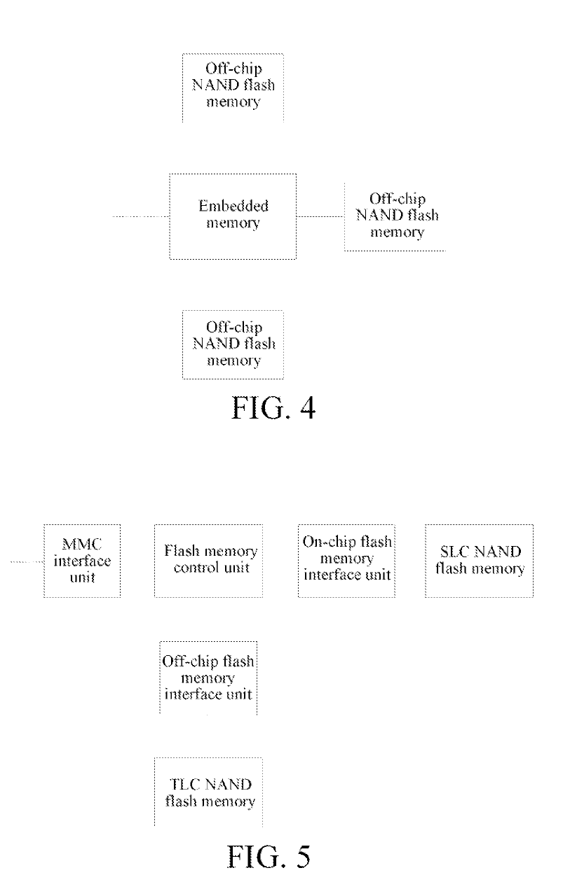

Please refer to FIG. 4. FIG. 4 is a schematic structural view of an embedded storage system according to Embodiment 2 of the present invention. The embedded storage system in this embodiment includes an on-chip NAND flash memory, a flash memory control unit, an MMC interface unit, an on-chip flash memory interface unit, and an off-chip flash memory interface unit, where an off-chip expanded NAND flash memory whose capacity is greater than the on-chip NAND flash memory is connected at an external end of an off-chip flash memory interface of an embedded memory.

In this embodiment, because one large-capacity NAND flash memory is connected, storage capacity is increased, so that storage expandability of the entire embedded storage system is improved.

In this embodiment, the embedded storage system may further use a plurality of off-chip flash memory interfaces that is connected to a flash memory controller and is disposed on NC pins of a BGA package to enable connection to a plurality of off-chip expanded NAND flash memories. Therefore, the storage capacity of the embedded storage system is further increased.

### Embodiment 3

Please refer to FIG. 5. FIG. 5 is a schematic structural view of an embedded storage system according to Embodiment 3 of the present invention. The embedded storage system in this embodiment includes an on-chip NAND flash memory, a flash memory control unit, an MMC interface unit, an on-chip flash memory interface unit, an off-chip flash memory interface unit, and one large-capacity off-chip NAND flash memory. The off-chip expanded NAND flash memory is connected to the off-chip flash memory interface unit. The on-chip NAND flash memory in this embodiment is an SLC NAND flash memory, and the off-chip expanded NAND flash memory is a TLC NAND flash memory.

In this embodiment, because the on-chip NAND flash memory and a flash memory controller are packaged in a BGA package, to increase use efficiency, an SLC NAND flash memory having a relatively long service life is chosen for use. For the off-chip expanded NAND flash memory, a TLC NAND flash memory having a relatively low production cost is chosen. This not only improves storage expandability of the entire embedded storage system, but also has an effect of adjusting and controlling a production cost.

In this embodiment, a plurality of off-chip expanded NAND flash memories may be connected to the embedded storage system, and the arrangement manner is the same as that in Embodiment 2, which is no longer elaborated here.

In addition, in this embodiment, the on-chip NAND flash memory may be arranged to be an MLC NAND flash memory or a TLC NAND flash memory. The off-chip NAND flash memory may be arranged to be an SLC NAND flash memory or an MLC NAND flash memory. It is proven by experiments that these arrangement manners may all prevent a work state of the entire embedded storage system from being affected, and may further achieve the objective of improving storage expandability of the embedded storage system by selecting several types of NAND flash memories and at the same time further improve controllability for a storage cost of a product and lower an overall storage cost.

The foregoing content is further detailed illustration of the present invention with reference to specific implementation manners, and it should not be construed that the specific implementations of the present invention are only limited to the illustration. Therefore, a person of ordinary skill in the technical field of the present invention may further make several simple derivations or replacements without departing from the concept of the present invention, and these derivations or replacements should be construed as falling within the protection scope of the present invention.

What is claimed is:

1. An embedded storage, comprising: a flash memory control unit and a host interface unit, and further comprising: at least one off-chip flash memory interface unit; wherein the flash memory control unit is connected to the host interface unit and the off-chip flash memory interface unit, and is used for implementing control on the host interface unit and the off-chip flash memory interface unit; the host interface unit provides an interface for a host externally, is connected to the flash memory control unit internally, and is used for implementing data interaction between the host and the flash memory control unit; and the off-chip flash memory interface unit provides externally an interface for performing data transmission with an expanded flash memory, is connected to the flash memory control unit internally, and is used for implementing data interaction between the expanded flash memory and the flash memory control unit.

2. The embedded storage according to claim 1, wherein the host interface unit is specifically an MMC interface unit for providing an MMC interface for the host.

3. The embedded storage according to claim 1, further comprising: an on-chip flash memory and an on-chip flash memory interface unit, wherein the on-chip flash memory is connected to the on-chip flash memory interface unit, and the on-chip flash memory interface unit is further connected to the flash memory control unit, and is used for implementing data interaction between the on-chip flash memory and the flash memory control unit.

4. The embedded storage according to claim 3, wherein the on-chip flash memory is an on-chip NAND flash memory.

5. The embedded storage according to claim 4, wherein the on-chip NAND flash memory is a single-level cell (SLC) NAND flash memory, a multi-level cell (MLC) NAND flash memory or a triple-level cell (TLC) NAND flash memory.

6. The embedded storage according to any one of claims 1 to 5, wherein the embedded storage is a ball grid array (BGA) package chip.

7. The embedded storage according to claim 6, wherein the interface for performing data transmission with an expanded flash memory provided by the off-chip flash memory interface unit is an NC pin of the BGA package chip.

8. The embedded storage according to claim 6, wherein the BGA package chip is a chip of an AA, AB, AC or BA specification.

9. An embedded storage system, comprising: the embedded storage according to claim 1 and at least one expanded flash memory, wherein the expanded flash memory is connected to an off-chip flash memory interface unit of the embedded memory.

10. The embedded storage system according to claim 9, wherein the expanded flash memory is an expanded NAND flash memory.

11. The embedded storage system according to claim 10, wherein the expanded NAND flash memory is a single-level cell (SLC) NAND flash memory, a multi-level cell (MLC) NAND flash memory or a triple-level cell (TLC) NAND flash memory.

12. The embedded storage system according to claim 11, wherein the on-chip NAND flash memory is an SLC NAND flash memory, and the expanded NAND flash memory is a TLC NAND flash memory.

13. The embedded storage system according to claim 9, wherein storage capacity of the expanded flash memory is greater than or equal to storage capacity of the on-chip flash memory.

14. The embedded storage system according to claim 13, wherein storage capacity of the expanded NAND flash memory is greater than or equal to storage capacity of the on-chip NAND flash memory.

15. The embedded storage according to claim 2, wherein the embedded storage is a ball grid array (BGA) package chip.

16. The embedded storage according to claim 3, wherein the embedded storage is a ball grid array (BGA) package chip.

17. The embedded storage according to claim 4, wherein the embedded storage is a ball grid array (BGA) package chip.

18. The embedded storage according to claim 5, wherein the embedded storage is a ball grid array (BGA) package chip.

19. The embedded storage system according to claim 10, wherein storage capacity of the expanded flash memory is greater than or equal to storage capacity of the on-chip flash memory.

20. The embedded storage system according to claim 11, wherein storage capacity of the expanded flash memory is greater than or equal to storage capacity of the on-chip flash memory.
